(19) United States
(12) Patent Application Publication
(10) Pub. No.: US 2013/0032274 A1
(43) Pub. Date: Feb. 7, 2013

(54) METHOD OF WRAPPING A BATT, BLANKET OR MAT IN AN EXHAUST GAS AFTERTREATMENT OR ACOUSTIC DEVICE

(71) Applicant: Ruth Latham, Ann Arbor, MI (US)

(72) Inventor: Ruth Latham, Ann Arbor, MI (US)

(21) Appl. No.: 13/196,307

(22) Filed: Aug. 2, 2011

(51) Int. Cl. B32B 37/02; B32B 37/12

(52) U.S. Cl. 156/160

(57) ABSTRACT

A method is provided for wrapping a mat (24) around a core in an exhaust gas aftertreatment or acoustic device. The method includes the steps of applying a longitudinally extending strip of adhesive media to the surface of the core; securing a first end of the mat (24) to at least a part of the strip of adhesive media; wrapping the mat (24) around the core for at least a complete wrap around the core; securing a second end of the mat (24) to at least a part of the strip of adhesive media.

### CROSS-REFERENCE TO RELATED APPLICATIONS

Not applicable.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This invention relates to exhaust gas aftertreatment and/or acoustic systems and the devices used therein that utilize insulation blankets, batts and mats.

### BACKGROUND OF THE INVENTION

Batts, blankets, and/or mats are utilized in exhaust gas systems in order to provide heat insulation and/or resilient mounting structure for acoustic and aftertreatment devices of the system to control the heat exchange to and from the devices and/or provide a protective mount for a core or other fragile component of the devices. It is known to place such batts/blankets/mats between adjacent wall surfaces of such devices with the material of the batts/blankets/mats being compressed to provide a desired installed density for the material to help maintain the batts/blankets/mats in a mounted position via frictional forces between the batts/blankets/mats and the adjacent wall surfaces. Typically, the adjacent wall surfaces are defined by a core or other internal component of the device and a can or housing that surrounds the core or other internal component with the batt/blanket/mat sandwiched between core/internal component and the can/housing.

Such a structure is shown in U.S. Ser. No. 12/894,712 filed Sep. 30, 2010 by Steven J. Myers, entitled “Method of Installing a Multi-Layer Batt, Blanket or Mat in an Exhaust Gas Aftertreatment or Acoustic Device”, the disclosure of which is hereby incorporated by reference.

Typically the batt/blanket/mat is wrapped around the core/internal component and the can/housing is installed by forcing the wrapped core/internal component into the can/housing causing the batt/blanket/mat to be sandwiched between the adjacent wall surfaces of the core/internal component and the can/housing. Often, during the installation process, when the batt/blanket/mat is being wound around the core/internal component, the tensile force being applied allows the batt/blanket/mat to slip along the circumference of the core/internal component, making installation difficult.

The present invention is directed to overcoming one or more of the problems set forth above.

### SUMMARY OF THE INVENTION

In accordance with one aspect of the present invention, a method is provided for manufacturing an exhaust gas aftertreatment or acoustic device. The method includes the steps of providing a core having an outer surface substantially cylindrical about a longitudinal axis; applying a longitudinally extending strip of adhesive media to the outer surface of the core; securing a first end of a mat to a first portion at least a part of the strip of adhesive media, said first portion being less than all of the media strip; wrapping the mat around the outer surface of the core for at least a complete wrap around the core; securing a second end of the mat to a second portion of the strip of adhesive media, said first and second portions being substantially all of the media strip; providing a housing having an inner surface; locating the mat and the core inside the housing whereby the mat is compressed between the outer surface of the core and inner surface of the housing.

According to one feature of this aspect of the invention, the installing method includes a first end of the mat is in a groove configuration and the second end of the mat is in a tongue configuration.

According to another feature of this aspect of the invention, the strip of adhesive media comprises of two-sided tape.

According to still another feature of this aspect of the invention, the strip of adhesive media comprises of spray adhesive.

In accordance with another aspect of the present invention, a method is provided for manufacturing an exhaust gas aftertreatment or acoustic device. The method includes the steps of applying a strip of adhesive media to at least a first and second end portion of a mat; securing the first end of the mat to the surface of the core along the longitudinal axis of the core; wrapping the mat around the outside surface of the core for at least a complete wrap around said core; securing the second end of the mat to the surface of the core along its longitudinal axis; providing a housing having an inner surface; locating the mat and the core inside the housing whereby the mat is compressed between the outer surface of the core and inner surface of the housing.

According to one feature of this aspect of the invention, the installing method includes a first end of the mat is in a groove configuration and the second end of the mat is in a tongue configuration.

According to another feature of this aspect of the invention, the strip of adhesive media comprises of two-sided tape.

According to still another feature of this aspect of the invention, the strip of adhesive media comprises of spray adhesive.

In accordance with another aspect of the invention, a method is provided for manufacturing an exhaust gas aftertreatment or acoustic device. The method includes the steps of: providing a core having a surface substantially cylindrical about a longitudinal axis; applying an adhesive to the surface of the core along at least part of its longitudinal axis whereby said adhesive having an adhesive surface outwardly facing from the core; securing a first end of a mat to at least a part of the adhesive; wrapping the mat around the outer surface of the core for at least one complete wrap around the core; providing a housing having an inner surface; locating the mat and the core inside the housing whereby the mat is compressed between the outer surface of the core and inner surface of the housing.

In accordance with another aspect of the present invention, a method is provided for manufacturing an exhaust gas aftertreatment or acoustic device. The method includes the steps of providing a core having an outer surface substantially cylindrical about a longitudinal axis; applying a strip of adhesive media to the surface of the core along at least part of its longitudinal axis; securing a first end of a mat to at least a part of the strip of adhesive media; wrapping the mat around the outer surface of the core for at least a complete wrap around the core; applying a second strip of adhesive media to a second end of the mat; securing the second end of the mat to the outer surface of the previous wrap.

According to one aspect of the invention, the strip of adhesive media comprises of two-sided tape.

According to another feature of this aspect of the invention, the strip of adhesive media comprises of spray adhesive.

### BRIEF DESCRIPTION OF THE DRAWINGS

FIG. 1 is a diagrammatic representation of an exhaust gas system employing the invention;

FIG. 2 is a section view of an exhaust system component employing the invention along line 2-2 in FIG. 1;

FIG. 3 is a top view of the a core of an exhaust system component with adhesive thereon pursuant to the invention;

FIG. 4 is an end view of the core of FIG. 3 with one end of the mat secured to the core in accordance with the invention;

FIG. 5 is an end view of the FIG. 3 core with one complete wrap of the mat pursuant to the invention;

FIG. 6 is a top view of the mat wrapped core of FIG. 5;

FIG. 7 is an end view of another embodiment of the present invention with the mat wrapped around the core multiple times.

### DETAILED DESCRIPTION OF THE PREFERRED EMBODIMENT

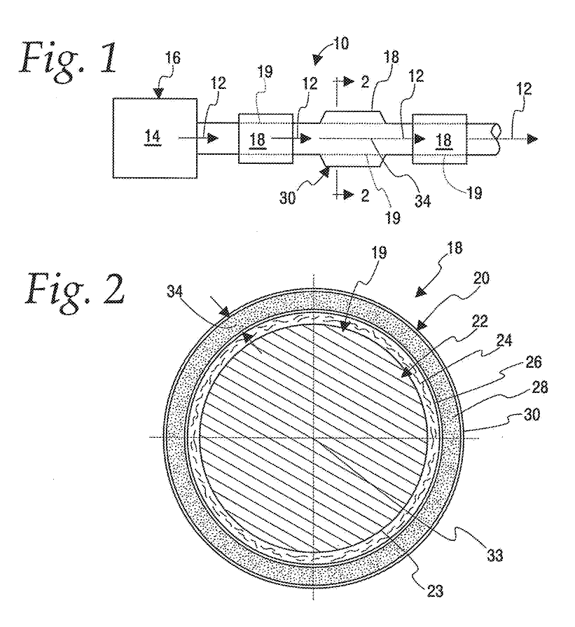

An exemplary exhaust gas system 10 with which the present invention may be used, is shown in FIG. 1 in the form of a diesel exhaust gas aftertreatment system to treat the exhaust 12 from a diesel combustion process 14, such as a diesel compression engine 16. The exhaust 12 will typically contain oxides of nitrogen (NOₓ) such as nitric oxide (NO) and nitrogen dioxide (NO₂) among others, particulate matter (PM), hydrocarbons, carbon monoxide (CO), and other combustion by-products. The system 10 includes one or more exhaust gas acoustic and/or aftertreatment devices or components 18. Examples of such devices 18 include catalytic converters, diesel oxidation catalysts, diesel particulate filters, gas particulate filters, lean NOₓ traps, selective catalytic reduction monoliths, burners, manifolds, connecting pipes, mufflers, resonators, tail pipes, emission control system enclosure boxes, insulation rings, insulated end cones, insulated end caps, insulated inlet pipes, and insulated outlet pipes, all of any cross-sectional geometry, many of which are known.

As those skilled in the art will appreciate, some of the foregoing devices 18 are strictly metallic components with a central core 19 through which the exhaust 12 flows, and other of the devices 18 can include a core 19 in the form of a ceramic monolithic structure and/or a woven metal structure through which the exhaust 12 flows. These devices 18 are conventionally used in motor vehicles (diesel or gasoline), construction equipment, locomotive engine applications (diesel or gasoline), marine engine applications (diesel or gasoline), small internal combustion engines (diesel or gasoline), and stationary power generation (diesel or gasoline).

FIG. 2 shows one example of such a device 18 for use in the system 10 in the form of a catalytic unit 20 having a catalytic core 22 with outer surface 23, a mount mat 24, a cylindrical inner housing or can 26 having an inner surface 27, a heat insulating blanket or batt 28, and a cylindrical outer housing or jacket 30. The core 22 will typically be a ceramic substrate 32 having a monolithic structure with a catalyst coated thereon and will typically have an oval, circular or other non-round cross section centered on a longitudinal axis 33 with the housing components 26 and 30 also being cylindrical in shape and centered on the axis 33. The mounting mat 24 is sandwiched between the outer surface 23 of the core 22 and the inner surface 27 of the can 26 to help protect the core 22 from shock and vibrational forces that can be transmitted from the can 26 to the core 22.

The heat insulating batt 28 is made of a silica fiber insulation material. Such material is known and commercially available, with one suitable example being supplied by BGF Industries, Inc. under the trade name SilcoSoft®, and another suitable example being supplied by ASGLAWO technofibre GmbH under the trade name Asglasil®. Such material is typically supplied in rolls, with the individual batts 28 being die cut to the appropriate length and width for the corresponding device 18 after the material has been taken from the roll. Preferably, the batt 28 is sandwiched or compressed in the annular gap 34 between the outer surface 36 of the can 26 and the inner surface 38 of the housing 30.

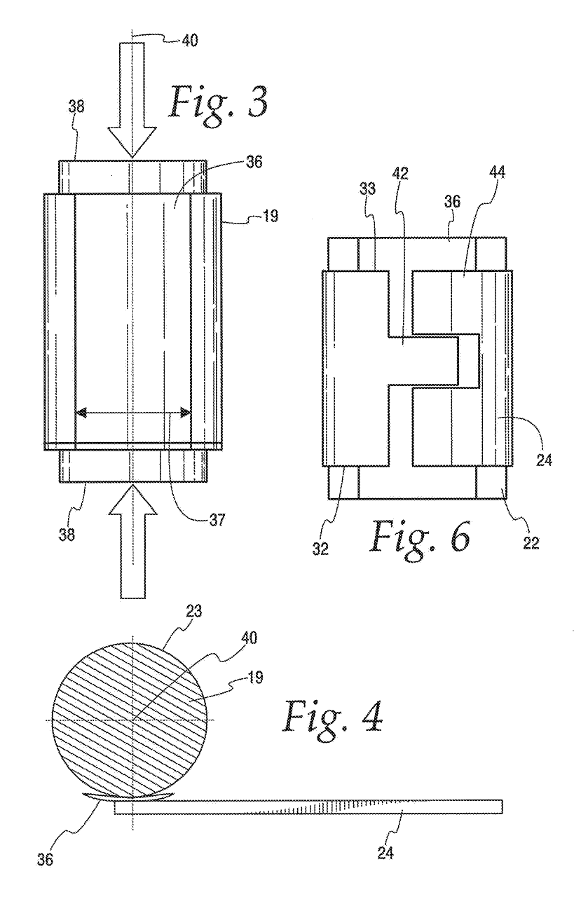

Referring to FIGS. 3 & 4, in accordance with the present invention, the first step in installing the mounting mat 24 consists of using a clamping mechanism 38 to clamp the core 22 along its axis such that it is prevented from rotating along its axis 40. Thereafter, a strip of adhesive media 36 is placed along the longitudinal axis 40 of the outer surface 23 of the core 22.

In the described embodiment, commercially available double sided tape is used as the adhesive media 36. In addition it is contemplated that other adhesives including spray adhesive can be used as adhesive 36.

The strip of adhesive media 36 is placed on the outer surface 23 of the core 22 such that the width 37 of adhesive media 36 is great enough to adequately grip the end of the mat 24 as its rolled around the core 22 as described herein. In one embodiment, the strip of adhesive media 36 is at least as wide as the tongue end 42 and groove end 44 of the mat 24. It should be appreciated that the adhesive media 36 can also be place on the ends of the mat alone or in combination with the core 22 providing the same advantages as described herein.

Referring to FIG. 4, once the adhesive media 36 is placed on the outer surface 23 of the core 22, the core 22 is rotated along its longitudinal axis 40 until the adhesive media strip 36 is generally located along the bottom of the core 22. According to the invention, the groove end 44 of the mat 24 is then placed below the core 22. The core 22 is lowered until it comes into contact with the groove end 44 of the mat 24 such that approximately one half of the width 37 of the adhesive media 36 previously placed on the surface 23 of the core 22 adheres and secures the groove end 44 of the mat 24 to the core 22.

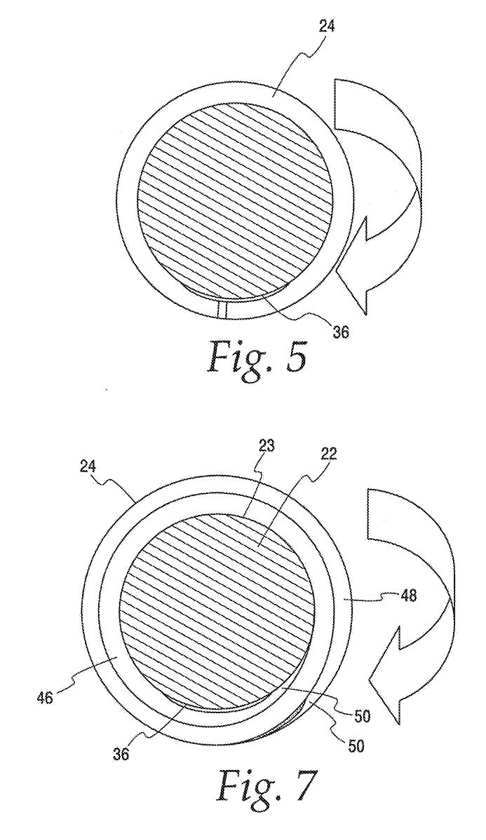

Referring to FIGS. 5 & 6, the core 22 is then rotated along its longitudinal axis 40 such that the mat 24 is wrapped around the outer surface 23 of core 22 transverse to the longitudinal axis 40 so that the mat 24 is in a constant position relative to the core 22 with the edges 32, 33 of the mat 24 being perpendicular to longitudinal axis 40. The adhesive media 36 secures the mat 24 to the core 22 such that the mat 24 does not slip transversely as the core 22 is rotated as described herein.

Once the mat 24 is wrapped around the outer surface 23 of the core 22, the tongue end 42 of the mat 24 is placed into the groove end 44 of the mat 24 and secured to the core 22 by adhering it to the approximately one half of the width 37 not adhered to the groove end 44 previously secured to the core 22. In this configuration, the mat 24 is attached to the core 22 such that it is easily moved to a separate location for insertion into the can 26.

FIG. 7 discloses a second embodiment wherein the catalytic unit 20 employs a multi layer mat design. With a multi layer mat design, the adhesive media 36 is placed on the outer surface 23 of the core 22 such that the width 37 of adhesive media 36 is great enough to adequately grip one end of the mat 24 as its rolled around the core 22 as described herein. It should be appreciated that the adhesive media 36 can also be place on the end of the mat alone or in combination with the core 22 providing the same advantages as described herein.

The core 22 is lowered until it comes into contact with one end of the mat 24 such that the adhesive media 36 previously placed on the surface 23 of the core 22 adheres and secures the end 50 of the mat 24 to the core 22.

The mat 24 is wrapped around the core 22 for the first wrap 46 as described above. Subsequent to the first wrap, the mat 24 is wrapped about the longitudinal axis 33, a successive number of times. As shown in FIG. 7, the embodiment shown contains one successive wrap 48. This final wrap 48 is accomplished by wrapping the mat 24 around the previous wrap 46 of the mat 24 transverse to the longitudinal axis. It should be appreciated that the number of successive wraps is determined based upon the requirements of the specific system.

It should also be appreciated that the method described allows for a more efficient installation process and allows the mat and core to be easily moved before installation into a can. In addition, the adhesive helps to reduce unsupported corners of the batt/blanket/mat during installation.

It should further appreciated that while the invention has been described herein in connection with a diesel combustion process in the form of a diesel compression engine 16, the invention may find use in devices that are utilized in exhaust gas systems for other types of combustion processes, including other types of internal combustion engines, including, for example, internal combustion engines that use gasoline or other alternative fuels.

1. A method of manufacturing an exhaust gas aftertreatment or acoustic device, the method comprising the steps of:
providing a core having an outer surface substantially cylindrical about a longitudinal axis;
applying a longitudinally extending strip of adhesive media to the outer surface of the core;
securing a first end of a mat to a first portion at least a part of the strip of adhesive media, said first portion being less than all of the media strip;
wrapping the mat around the outer surface of the core for at least a complete wrap around the core;
securing a second end of the mat to a second portion of the strip of adhesive media, said first and second portions being substantially all of the media strip.
providing a housing having an inner surface;
locating the mat and the core inside the housing whereby the mat is compressed between the outer surface of the core and inner surface of the housing.

2. The method of claim 1 wherein the first end of the mat is in a groove configuration and the second end of the mat is in a tongue configuration.

3. The method of claim 1 wherein the strip of adhesive media comprises two-sided tape.

4. The method of claim 1 wherein the strip of adhesive media comprises spray adhesive.

5. A method of manufacturing an exhaust gas aftertreatment or acoustic device, the method comprising the steps of:
providing a mat having a first end portion and a second end portion;
providing a core having an outer surface substantially cylindrical about a longitudinal axis;
applying adhesive media to the first end portion and the second end portion of the mat;
securing the first end of the mat to the surface of the core along the longitudinal axis of the core;
wrapping the mat around the outside surface of the core for at least a complete wrap around said core;
securing the second end of the mat to the surface of the core along its longitudinal axis.
providing a housing having an inner surface;
locating the mat and the core inside the housing whereby the mat is compressed between the outer surface of the core and inner surface of the housing.

6. The method of claim 5 wherein the first end of the mat is in a groove configuration and the second end of the mat is in a tongue configuration.

7. The method of claim 5 wherein the adhesive media comprises two-sided tape.

8. The method of claim 5 where in the adhesive media comprises spray adhesive.

9. A method of manufacturing an exhaust gas aftertreatment or acoustic device the method comprising the steps of:
providing a core having a surface substantially cylindrical about a longitudinal axis;
applying an adhesive to the surface of the core along at least part of its longitudinal axis whereby said adhesive having an adhesive surface outwardly facing from the core;
securing a first end of a mat to at least a part of the adhesive;
wrapping the mat around the outer surface of the core for at least one complete wrap around the core;
providing a housing having an inner surface;
locating the mat and the core inside the housing whereby the mat is compressed between the outer surface of the core and inner surface of the housing.

10. The method of claim 9 wherein the adhesive comprises two-sided tape.

11. The method of claim 9 wherein the adhesive comprises spray adhesive.
